(19) United States
(12) Patent Application Publication
(10) Pub. No.: US 2024/0393514 A1
(43) Pub. Date: Nov. 28, 2024

(54) High Refractive Index Quantizing Nanolaminates

(71) Applicants: Laser Zentrum Hannover e.V., Hannover (DE); Fraunhofer-Gesellschaft zur Förderung der angewandten Forschung e.V., Munich (DE)

(72) Inventors: Marco Jupé, Hannover (DE); Michael Vergöhl, Cremlingen (DE); Thomas Willemsen, Hannover (DE); Stefan Bruns, Cremlingen (DE)

(21) Appl. No.: 18/606,673

(22) Filed: Mar. 15, 2024

(30) Foreign Application Priority Data
May 26, 2023 (EP) 23 175 691.7

(51) Int. Cl. G02B 5/28

(52) U.S. Cl. CPC G02B 5/28

(57) ABSTRACT

A high refractive index quantizing nanolaminate comprises a sequence of alternating first laminas made of a high refractive index material having a first absorption edge and second laminas of a barrier material having a second absorption edge. The second absorption edge is by at least 0.1 eV higher than the first absorption edge. The first laminas define potential wells delimited by the second laminas. An effective absorption edge of the high refractive material in the potential wells is by at least 0.1 eV higher than the first absorption edge; and the high refractive material is a semiconductor.

### CROSS REFERENCE TO RELATED APPLICATIONS

The application claims priority to abandoned European Patent Application No. EP 23 175 691.7 filed on May 26, 2023, and entitled “Hochbrechende quantisierende Nanolaminate”.

### FIELD OF THE INVENTION

The present invention relates to a high refractive index quantizing nanolaminate which may, for example, be used in forming multi-layer optical coatings. Further, the present invention relates to an optical device comprising a multi-layered optical coating comprising such nanolaminates.

### BACKGROUND OF THE INVENTION

The performance of multi-layered optical coatings depends on the difference in refractive index between high refractive index and low refractive index layers of the coating. Particularly in optical filters, a high difference in refractive index is essential. If, for example, a high reflective mirror having a reflectivity of more than 99.9% for light of a wavelength of 1,063 nm is made using low refractive index layers of SiO₂ more than 60 layers and an overall coating thickness of more than 10 μm are needed if the high refractive index layers are made of Al₂O₃, whereas with high refractive index layers TiO₂, due to the higher refractive index of TiO₂, 19 layers and an overall coating thickness of 3 μm are sufficient.

A higher refractive index of an optical material is generally connected with a lower absorption edge of the optical material. Thus, optical materials with a very high refractive index comprise such a low absorption edge that they are at best useable for light of very long wavelengths in which the photon energy remains below the absorption edge.

M. Steinecke et al.: “Quantizing nanolaminates as versatile materials for optical interference coatings”, Applied Optics, Vol. 59, No. 5, 10 Feb. 2020, pages A236-A241, disclose to break up the link between refractive index and absorption edge of an optical material in that a high refractive index layer of an optical coating is not continuously made of a high refractive index metal oxide but as a nanolaminate comprising a sequence of first laminas of the high refractive metal oxide and second laminas of silicon oxide, wherein the first laminas form potential wells delimited by the second laminas. With lamina thicknesses of the first laminas below 5 nm and preferably below 2 nm, the energy states of the high refractive index material in the potential wells is quantized. This quantization causes a significant increase in the effective absorption edge of the high refractive index material in the potential wells, which is equal to the effective absorption edge of the entire nanolaminate. The effective refractive index of the nanolaminate depends on the ratio of the lamina thicknesses of the first laminas and the second laminas. Overall, the effective absorption edge of the high refractive metal oxide may be increased by means of these known nanolaminates made of a high refractive index metal oxide in the potential wells and SiO₂ as a barrier material between the potential wells such that the nanolaminate is suitable for light of shorter wavelengths than the metal oxide alone. The nanolaminate has a refractive index which is reduced as compared to the refractive index of the pure metal oxide. However, there is an advantage due to the expansion of the wavelength range in which the high refractive index metal oxide may be used.

There still is a need of a nanolaminate which has an even higher effective refractive index than the known nanolaminates made of metal oxide and SiO₂.

### SUMMARY OF THE INVENTION

The present invention relates to a high refractive index quantizing nanolaminate. The high refractive index quantizing nanolaminate comprises a sequence of alternating first laminas made of a high refractive index material having a first absorption edge and second laminas of a barrier material having a second absorption edge. The second absorption edge is by at least 0.1 eV higher than the first absorption edge. The first laminas define potential wells delimited by the second laminas. An effective absorption edge of the high refractive material in the potential wells is by at least 0.1 eV higher than the first absorption edge; and the high refractive material is a semiconductor.

The present invention further relates to an optical device comprising a multi-layer optical coating consisting of a sequence of consecutive layers of a higher layer refractive index of at least 2.8 for light of a wavelength of 800 nm, and second laminas of a lower lamina refractive index of less than 2.4 for light of the wavelength of 800 nm. At least one of the layers of a higher layer refractive index is a high refractive index quantizing nanolaminate. The high refractive index quantizing nanolaminate comprises a sequence of alternating first laminas made of a high refractive material having a first absorption edge and second laminas of a barrier material having a second absorption edge. The second absorption edge is by at least 0.1 eV higher than the first absorption edge. The first laminas define potential wells delimited by the second laminas. An effective absorption edge of the high refractive material in the potential wells is by at least 0.1 eV higher than the first absorption edge. The high refractive material is a semiconductor

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 schematically shows the design of a quantizing nanolaminate comprising five first laminas of high refractive index silicon between second laminas of silicon oxide, wherein the band structures and resulting probabilities to find electrons are plotted.

FIG. 2 is a depiction corresponding to FIG. 1 showing a nanolaminate comprising 20 first laminas of silicon between second laminas of silicon oxide.

FIG. 3 is a phase diagram of the system silicon/silicon oxide and shows all possible material parameter combinations of refractive index and absorption edge which may be achieved with the semiconductor based quantizing nanolaminate.

FIG. 4 is a phase diagram corresponding to FIG. 3 of the system germanium/germanium oxide.

FIG. 5 shows a multi-layer optical coating made of consecutive first layers of a higher layer refractive index and second layers of a lower layer refractive index, wherein several of the first layers consist of semiconductor based quantizing nanolaminates; and

FIG. 6 shows a further multi-layer optical coating consisting of consecutive first layers of higher layer refractive index and second layers of lower layer refractive index, wherein all first layers are made of semiconductor based quantizing nanolaminates.

### DETAILED DESCRIPTION

A high refractive index semiconductor based quantizing nanolaminate comprises a sequence of alternating first laminas of a high refractive index material having a first absorption edge and second laminas of a barrier material having a second absorption edge which is by at least 0.1 eV higher than the first absorption edge. The first laminas define potential wells delimited by the second laminas. An effective absorption edge of the high refractive index material in the semiconductor based quantizing nanolaminates is by at least 0.1 eV higher than the first absorption edge. The high refractive index material is a semiconductor.

Even compared to metal oxides, many semiconductors have a very high refractive index. However, due to their low absorption edge which is determined by the comparably small distance of the lower edge of their conduction band to the upper edge of their valence band, semiconductors are, as a rule, not suited for optical application like the formation of optical coatings of alternating high refractive index and low refractive index layers. In the semiconductor based quantizing nanolaminate, a semiconductor is used as the high refractive index material in the potential wells so that the effective absorption edge of the semiconductor is increased due to the formation of the potential wells. Preferably, the increase of the absorption edge is at least 0.2 eV, and, even more preferably, it is at least 0.5 eV. The increase in the absorption edge may be at least 1 eV or 2 eV or even more. As a result, the semiconductor becomes suitable for practical optical applications, particularly for optical coatings.

In the semiconductor based quantizing nanolaminate, the potential wells always result in a particularly high relative increase of the effective absorption edge with respect to the, from an absolute point view, low absorption edge of the semiconductor. If, by means of the boundary conditions or constrains of the potential wells, the entire lower conduction band of the semiconductor is blocked, there also is a high absolute increase in the effective absorption edge of the semiconductor.

The use of the semiconductor as the higher refractive index material in the potential wells further allows for using a still comparatively high refraction index material as the barrier material delimiting the potential wells. However, preferably, the second absorption edge of the barrier material is higher than the first absorption edge semiconductor not only by 0.1 eV but by at least 0.5 eV higher. More preferably, the second absorption edge of the barrier material is by at least 1 eV higher, and, even more preferably, it is by at least 3 eV or even at least 5 eV higher. Even then, barrier materials having a comparatively high refractive index may be used.

The semiconductor based nanolaminate forming a plurality of potential wells is typically by at least 89%, preferably by at least 99% and even more preferably by at least 99.5% transparent for light of a wavelength of 800 nm. Preferably, this applies for light of any wavelength in a wavelength range from 400 nm, 500 nm or at least 600 nm up to 1.500 nm, 1200 nm or at least 1.000 nm. This is achieved in that the effective absorption edge of the semiconductor and the nanolaminate is at least higher than the photon energy of light of the wavelength of 600 nm, i.e. at least about 2.1 eV.

The semiconductor based quantizing nanolaminate may have a usable effective refraction index of at least 2.5, preferably of at least 2.8 and even more preferably of at least 3.2 for light of the wavelength of 800 nm. Thus, the effective refractive index usable due to sufficient transparency of the nanolaminate is clearly higher than the refractive index of pure metal oxide. For example, the refractive index of pure titanium oxide for light of the wavelength of 800 nm is less than 2.4. Thus, the semiconductor based quantizing nanolaminate is a considerable step upwards with respect to the refractive index of high refractive index layers of optical coatings.

The semiconductor based quantizing nanolaminate may have the above mentioned high effective refractive index of at least 2.5, 2.8 or 3.2 not even for the light of the wavelength of 800 nm, but also for light of any wavelength in the wavelength range from 400 nm, 500 nm or at least 600 nm to 1.500 nm, 1.200 nm or at least 1.000 nm.

In the semiconductor based quantizing nanolaminate, the high refractive material of all first laminas may be the same, and the barrier material of all second laminas may also be the same. By means of using only one semiconductor for all first laminas and only one barrier material for all second laminas, the manufacture of the semiconductor based quantizing nanolaminate is simplified. However, generally, different semiconductors and different barrier materials may be used in the individual first and second laminas of the semiconductor based quantizing nanolaminate.

Practically, the high refractive index material may be selected from the group IV, group III-V and group II-VI semiconductors. More particularly, the high refractive index material may be selected from the semiconductors silicon, germanium GaAs and GaP.

Besides its composition, its refractive index is a criterion for selecting the semiconductor. This first refractive index may preferably be at least 4, which is the case with the above listed semiconductors.

In the quantizing nanolaminate, the semiconductor as the high refractive index material may be present in an amorphous, partially crystalline or crystalline phase. On an individual basis, the semiconductor is to be provided in such a phase with which the potential wells of the desired size can be formed without problem and which is stable in the desired use of the quantizing nanolaminate. Further, the semiconductor may first be deposited in an amorphous or partially crystalline phase and then be partially crystallized or fully crystallized. It is to be understood that the phase in which the semiconductor is present has an influence on its optical and electrical properties.

The quantizing nanolaminate forms at least two potential wells and thus comprises at least two first laminas between three second laminas. Thus, a minimum total thickness of the nanolaminate is two times the thickness of the first laminas and three times the thickness of the second laminas. However, it has to be pointed out that neither the first nor the second laminas have to have constant lamina thicknesses. Without considering a substrate on which the nanolaminate will be arranged as a rule, a total thickness of the quantizing nanolaminate will, as a rule, not be bigger than 100 times a design wavelength of light for which the nanolaminate is provided. Thus, if the nanolaminate is provided for light of a wavelength of 1,000 nm, the nanolaminate as such is not thicker than 100 μm. As a rule, the total thickness of the nanolaminate is smaller, and it typically is somewhere between half the design wavelength and a small multiple of the design wavelength. Here, the indication that the total thickness of x times the design wavelength is to be understood in that not the nominal value of the design wavelength in vacuum but the effective wavelength in the nanolaminate is decisive.

As a rule, a first lamina thickness of the first laminas made of the semiconductor is smaller than 5 nm, preferably smaller than 2 nm and even more preferably smaller than 1 nm in the quantizing nanolaminate. As long as the above criterions for the effective absorption edge are fulfilled, the first lamina thickness of the first laminas may also be higher than 5 nm. The smaller the first lamina thickness the higher the effective absorption edge as compared to the absorption edge of the semiconductor. However, conduction band gaps in the semiconductor may have the result that, in certain ranges of the first lamina thickness, a further reduction of the first lamina thickness will not result in a further increase in the effective absorption edge.

A barrier lamina thickness of the second laminas is typically at least 0.1 nm, preferably at least 0.2 nm and even more preferably 0.5 nm. These indications relate to an average or effective barrier lamina thickness of the second laminas. Even a second lamina which does not comprise a complete, i.e. closed layer of atoms, may already have a sufficient barrier function. For a simple formation of the second laminas with a secure function as barrier laminas, a barrier lamina thickness may be suitable which corresponds to more than one closed layer of atoms. There is no fixed upper limit for the barrier lamina thickness. However, the proportion of the barrier material in the nanolaminate increases with increasing barrier lamina thickness, which reduced the effective refractive index of the nanolaminate. Thus, generally, a small barrier lamina thickness is advantageous.

The first lamina thickness of all first laminas may be the same, and the barrier lamina thickness of all second laminas may be the same, so that the nanolaminate has a constant effective refractive index over its entire total thickness. However, generally, the effective refractive index may be varied over the thickness of the nanolaminate, particularly by varying the barrier lamina thickness. Then, the high values of the effective refractive index as they have ben indicated above only results over a few laminas of the nanolaminate, whereas the refractive index gets closer to that one of the barrier material in the area of other laminas. In this way, rugate structures or other structures with a quasi-steadily varying effective refractive index may be provided with the quantizing nanolaminate.

The not as high refractive index barrier material of the semiconductor based quantizing nanolaminate will have a second refractive index of at least 1.2 for the light of the wavelength of 800 nm. Preferably, this refractive index is at least 1.4, and even more preferably it is at least 1.45. As a rule, the second refractive index for the light of the wavelength of 800 nm will be by at least 0.3 and often by at least 0.85 smaller than the first refractive index of the semiconductor. It is decisive that the above defined requirements for the second absorption edge of the barrier material are fulfilled, wherein—within this constraint—a barrier material with an as high as possible second refractive index may be selected.

An optical device comprises a multi-layer optical coating made of a sequence of alternating first layers having a higher refractive index and second layers having a lower refractive index of less than 2.4 for the light of the wavelength of 800 nm. At least one of the first layers is made of a semiconductor based quantizing nanolaminate. Preferably, the refractive index of the second layers is smaller than 2, and even more preferably smaller than 1.5 for the light of the wavelength of 800 nm. In this way, a very high difference in refractive index is achieved between the semiconductor based quantizing nanolaminates in the first layers and the second layers of the low refractive index so that, for example, optical mirrors of high refractivity can be realized with a low number of layers and a low overall coating thickness.

All techniques which allow for depositing atoms at a precision of single atom layers are suitable as techniques for manufacturing semiconductor based quantizing nanolaminates and optical devices with an optical coating comprising such quantizing nanolaminates. The deposited laminas may, as already explained, be present in an amorphous, partially crystalline or crystalline phase, i.e. in different crystallization states, wherein the different phases result in different optical and electronical properties of the respective laminas, that have to be taken into consideration. Practical methods of depositing the laminas include epitaxic methods like molecular beam epitaxy (MBE) and metal-organic chemical vapor deposition (MOCVD) and, particularly, ion beam sputtering (IBS), magnetron sputtering and atomic layer deposition (ALD).

Due to the low absorption of the semiconductor based quantizing nanolaminates, they and optical coatings produce therefrom show good prepositions for a high destruction limit.

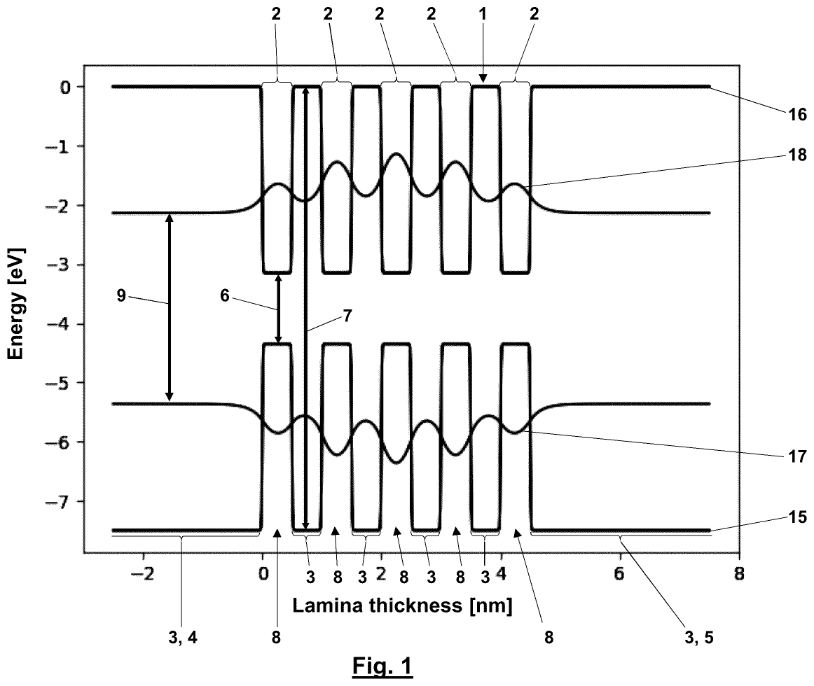

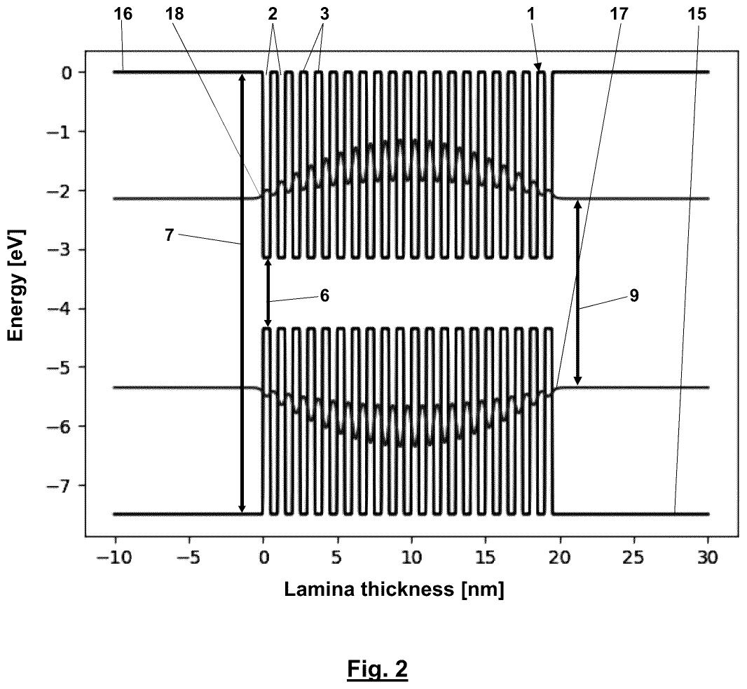

Referring now in greater detail to the drawings, FIG. 1 schematically shows a semiconductor based quantizing nanolaminate 1. In the present embodiment, the nanolaminate 1 has five first laminas 2 made of a high refractive index material between second laminas 3 of a barrier material. Here, a lowermost second lamina may be provided by a substrate on which the nanolaminate 1 is arranged. Alternatively, the lowermost lamina 4, for example in a multi-layer optical coating in which the nanolaminate 1 forms a first layer of a higher refractive index, may be a second layer of a lower refractive index adjoining this first layer. Similarly, an uppermost second lamina 5 may be made as a cover lamina or as such a second layer of a lower refractive index adjoining the first layer. The high refractive index material of the first laminas is a semiconductor, i. e. silicon in the present embodiment, which has a high refractive index but a low absorption edge 6, only, i.e. an only small distance between an upper edge 15 of its valence band and a lower edge 16 of its conduction band. The barrier material of the second laminas has a lower refractive index but a higher absorption edge 7 than the high refractive index material of the first laminas 2. Practically, the barrier material is silicon oxide having a high distance between its valence band upper edge 15 and its conduction band lower edge 16, here. The resulting difference between the absorption edges 6 and 7 is over 6 eV. The first laminas 2 delimited by the second laminas 3 form potential wells 8. In the potential wells 8, the possible electronic states are delimited. This results in a probability 17 to find the electrons in the valence band and a probability 18 to find the electrons in the conduction band, whose minimum distance means an effective absorption edge 9 in the nanolaminate 1 which is considerably increased as compared to the absorption edge 6 of the high refractive index material of the first layers 2. Due to the delimited possible electronic states, the nanolaminate is also designated as a quantizing nanolaminate.

Whereas FIG. 1 shows five first laminas 2 of about 0.5 nm thickness between second laminas 3 whose thickness between the first laminas 2 is also about 0.5 nm, FIG. 2 shows a total of 20 first laminas 2 between second laminas 3 of same thicknesses as in FIG. 1 so that the total thickness of the nanolaminate is increased from 5 nm to 20 nm.

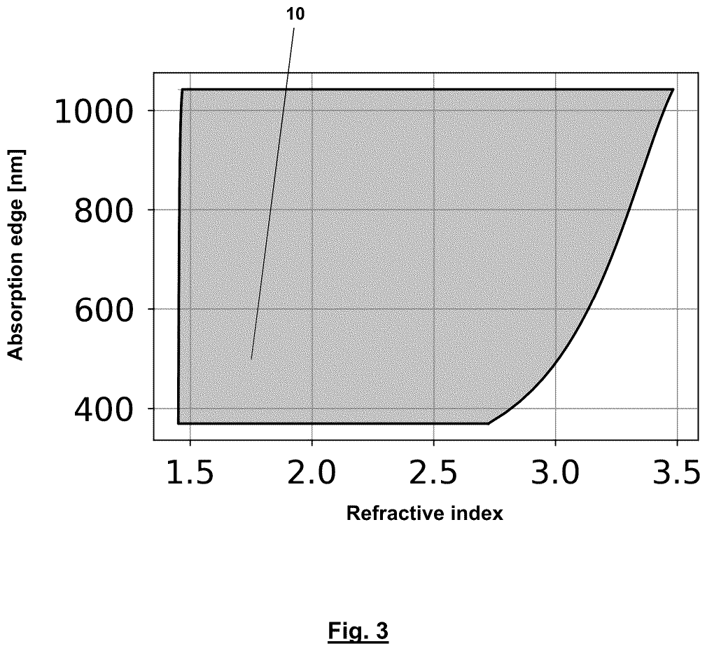

FIG. 3 is a phase diagram of a system comprising silicon as the high refractive index material and germanium oxide as the barrier material in the quantizing nanolaminate 1. An area 10 plotted in FIG. 3 over the refractive index and the absorption edge, the letter being indicated in nanometers, is accessible with the quantizing nanolaminate 1 having first laminas 2 of silicon on second laminas 3 of silicon oxide by means of different first lamina thicknesses of the first laminas 2 and second laminas thicknesses of the second laminas 3. FIG. 3 also shows that, even with a refractive index of more than 2.5, an absorption edge of above 400 nm can be achieved so that the semiconductor based quantizing laminate 1 is usable in optical coatings for light down to a design wavelength of 400 nm.

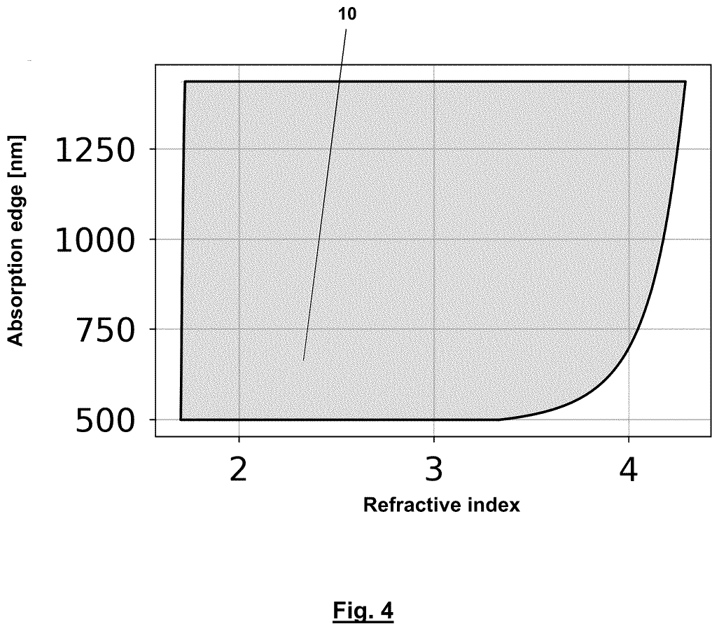

FIG. 4 is a phase diagram corresponding to FIG. 3 of a system comprising germanium as the high refractive index material and germanium oxide as the barrier material in the quantizing nanolaminate 1. Here, the absorption edge reachable towards shorter wavelengths ends at 500 nm. However, it ranges towards longer wavelengths up to about 1,400 nm so that the indicated refractive index of clearly above 3 can be utilized at any wavelength between 500 nm and 1,400 nm.

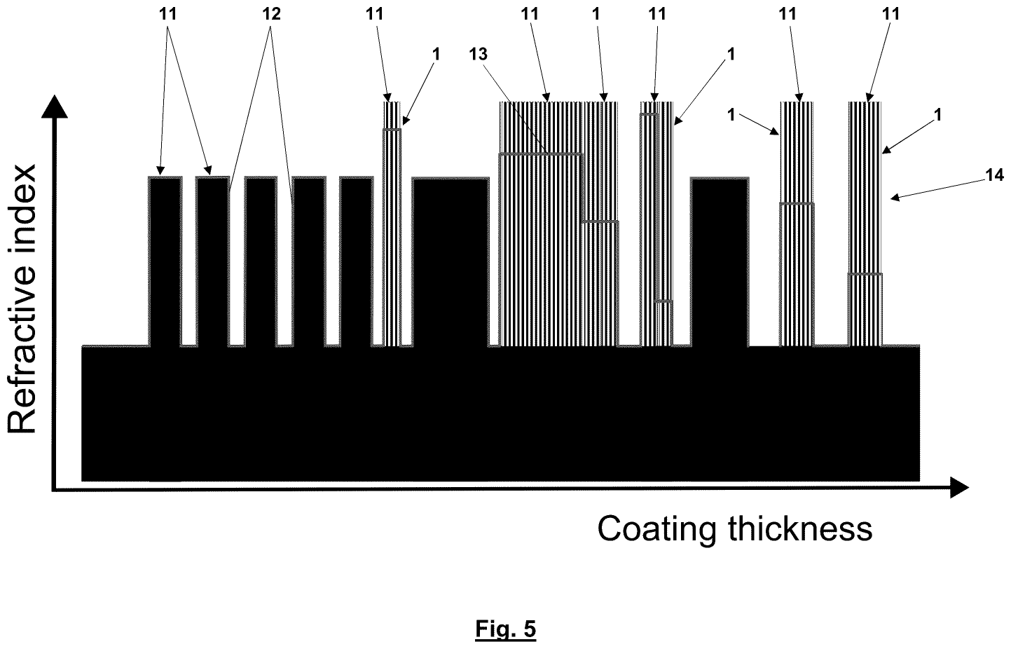

FIG. 5 illustrates a multi-layer optical coating in which the refractive indices of alternating first layers 11 of higher refractive index and second layers 12 of lower refractive index are plotted over a coating thickness. Here, the individual first layers 11 of higher refractive index are made as semiconductor based quantizing nanolaminates 1 for which the effective refractive index 13 is additionally plotted. By means of the first and the second lamina thicknesses of the semiconductor based quantizing nanolaminates 1, different effective refractive indexes can be realized within one quantizing nanolaminate as depicted.

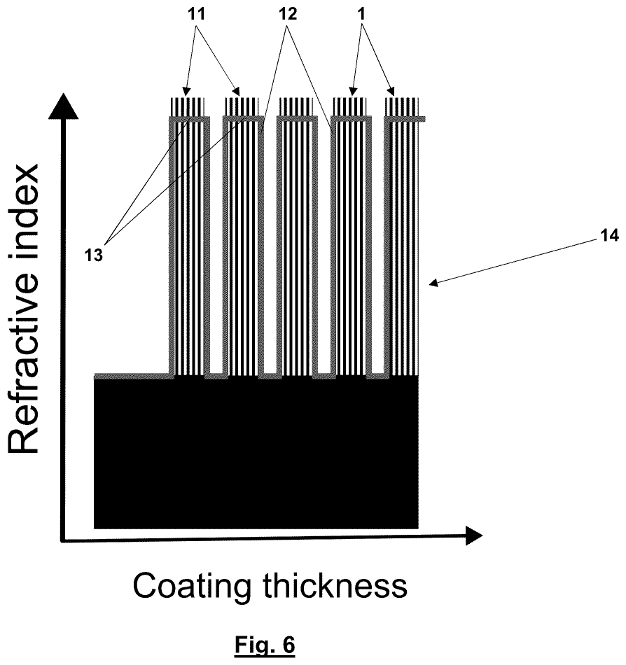

FIG. 6 is a plot corresponding to FIG. 5 for an optical coating in which all layers 11 of the higher refractive index are made as semiconductor based quantizing nanolaminates 1.

Many variations and modifications may be made to the preferred embodiments of the invention without departing substantially from the spirit and principles of the invention. All such modifications and variations are intended to be included herein within the scope of the present invention, as defined by the following claims.

We claim:

1. A high refractive index quantizing nanolaminate comprising
a sequence of alternating first laminas made of a high refractive index material having a first absorption edge and second laminas of a barrier material having a second absorption edge, the second absorption edge being by at least 0.1 eV higher than the first absorption edge,
wherein the first laminas define potential wells delimited by the second laminas, wherein an effective absorption edge of the high refractive material in the potential wells is by at least 0.1 eV higher than the first absorption edge, and
wherein the high refractive material is a semiconductor.

2. The nanolaminate of claim 1, wherein the barrier material is a semiconductor or a dielectric, wherein the second absorption edge is by at least 0.2 eV higher than the first absorption edge, and wherein the effective absorption edge of the high refractive index material in the potential wells is by at least 0.2 eV higher than the first absorption edge.

3. The nanolaminate of claim 1, wherein the barrier material is a semiconductor or a dielectric, wherein the second absorption edge is by at least 0.5 eV higher than the first absorption edge, and wherein the effective absorption edge of the high refractive index material in the potential wells is by at least 0.5 eV, higher than the first absorption edge.

4. The nanolaminate of claim 2, wherein the nanolaminate is by at least 99.5% transparent for light of a wavelengths of 800 nm.

5. The nanolaminate of claim 2, wherein the nanolaminate is by at least 99% transparent for light of any wavelength in a wavelength range from 400 nm to 1,400 nm.

6. The nanolaminate of claim 4, wherein the nanolaminate comprises an effective refractive index of at least 3.2 for light of the wavelength of 800 nm.

7. The nanolaminate of claim 6, wherein the nanolaminate comprises the effective refractive index of at least 3.2 for light of any wavelength in a wavelength range from 400 nm to 1,400 nm.

8. The nanolaminate of claim 1, wherein the high refractive index material of all first laminas is the same high refractive index material and wherein the barrier material of all second laminas is the same barrier material.

9. The nanolaminate of claim 1, wherein the high refractive index material is selected from the group IV, group III-V and group II-VI semiconductors.

10. The nanolaminate of claim 9, wherein the high refractive index material is selected from silicon, germanium, GaAs and GaP.

11. The nanolaminate of claim 1, wherein the first refractive index of the semiconductor is at least 4.

12. The nanolaminate of claim 1, wherein the nanolaminate comprises at least two first laminas between three second laminas, and wherein a total thickness of the nanolaminate is not higher than 100 times a design wavelength of light for which the nanolaminate is provided.

13. The nanolaminate of claim 1, wherein a lamina thickness of the first laminas is smaller than 5 nm.

14. The nanolaminate of claim 1, wherein a lamina thickness of the first laminas is smaller than 1 nm.

15. The nanolaminate of claim 13, wherein a barrier thickness of the second laminas is at least 0.1 nm.

16. The nanolaminate of claim 15, wherein the lamina thickness of all first laminas is the same lamina thickness, and wherein the barrier thickness of all second laminas is the same barrier thickness.

17. The nanolaminate of claim 1, wherein the second refractive index of the barrier material for light of a wavelength of 800 nm is at least 1.4.

18. The nanolaminate of claim 1, wherein the second refractive index of the barrier material for light of a wavelength of 800 nm is by at least 0.85 smaller than the first refractive index of the semiconductor.

19. An optical device comprising a multi-layer optical coating consisting of a sequence of consecutive layers of a higher layer refractive index of at least 2.8 for light of a wavelength of 800 nm, and second laminas of a lower lamina refractive index of less than 2.4 for light of the wavelength of 800 nm, wherein at least one of the layers of a higher layer refractive index is a high refractive index quantizing nanolaminate comprising
a sequence of alternating first laminas made of a high refractive material having a first absorption edge and second laminas of a barrier material having a second absorption edge, the second absorption edge being by at least 0.1 eV higher than the first absorption edge,
wherein the first laminas define potential wells delimited by the second laminas, wherein an effective absorption edge of the high refractive material in the potential wells is by at least 0.1 eV higher than the first absorption edge, and
wherein the high refractive material is a semiconductor.

20. The optical device of claim 19, wherein the higher layer refractive index is at least 3.2 for light of any wavelength in a wavelength range from 400 nm to 1,400 nm, and the lower lamina refractive index is less than 1.5 for light of any wavelength in the wavelength range from 400 nm to 1,400 nm.
